(19) United States
(12) Patent Application Publication
(10) Pub. No.: US 2025/0232306 A1
(43) Pub. Date: Jul. 17, 2025

(54) REDUCING HIGH-RISK BLOCKCHAIN TRANSACTION BEHAVIOR ASSOCIATED WITH FIAT CURRENCY ACCOUNTS

(71) Applicant: MASTERCARD INTERNATIONAL INCORPORATED, PURCHASE, NY (US)

(72) Inventors: Marianne Iannace, Branford, CT (US); Diarmuid Considine, Leixlip (IE); Shannon Holland, San Francisco, CA (US)

(21) Appl. No.: 18/415,643

(22) Filed: Jan. 17, 2024

(51) Int. Cl. G06Q 20/40

(52) U.S. Cl. CPC G06Q 20/4016; G06Q 20/405

(57) ABSTRACT

A computerized method monitors blockchain behavior associated with fiat currency accounts and generates notifications based on detected high-risk blockchain behavior. A transaction key associated with an on-ramp transaction is received. Based on fuzzy logic rules applied to transaction data of the on-ramp transaction and blockchain transaction data, a group of blockchain transactions are identified that are likely to be associated with the fiat currency account of the on-ramp transaction. A blockchain risk model is used with the identified group of blockchain transactions to determine that blockchain transaction behavior associated with the fiat currency account includes high-risk behavior and the financial institution (FI) of the on-ramp transaction is notified of the high-risk behavior, whereby the FI is enabled to take action to prevent future high-risk behavior. Thus, the method reduces the occurrence of costly malicious events using blockchain transactions and accounts are better secured against such events.

### BACKGROUND

Scams and other malicious transaction-based behavior often occur in association with cryptocurrencies due to the relative anonymity of such cryptocurrencies when compared to fiat currencies. As a result, many banks feel it is necessary to outright reject some or all cryptocurrency transactions to avoid the possibility of aiding in the scams and/or having to spend resources to help their customers in response to the scams or other malicious behavior. The distributed nature and anonymity of blockchain systems associated with cryptocurrencies presents significant technological challenges in detecting and preventing high-risk blockchain transaction behaviors.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for monitoring blockchain behavior associated with fiat currency accounts and generating notifications based on detected high-risk blockchain behavior is described. A transaction key associated with an on-ramp transaction is received. Based on fuzzy logic rules applied to transaction data of the on-ramp transaction and blockchain transaction data, a group of blockchain transactions are identified that are likely to be associated with the fiat currency account of the on-ramp transaction. A blockchain risk model is used with the identified group of blockchain transactions to determine that blockchain transaction behavior associated with the fiat currency account includes high-risk behavior and the financial institution (FI) of the on-ramp transaction is notified of the high-risk behavior, whereby the FI is enabled to take action to prevent future high-risk behavior.

### BRIEF DESCRIPTION OF THE DRAWINGS

The present description will be better understood from the following detailed description read considering the accompanying drawings, wherein:

FIG. 1 is a block diagram illustrating a system configured for identifying high-risk blockchain behavior and for sending notifications associated with the identified high-risk blockchain behavior;

FIG. 2 is a flowchart illustrating a method for linking an on-ramp transaction to one or more blockchain transactions using fuzzy logic rules;

FIG. 3 is a flowchart illustrating a method for generating an account risk rating of an account using a blockchain risk model;

FIG. 4 is a flowchart illustrating a method for identifying high-risk blockchain behavior associated with a fiat currency account and performing a mitigating action to prevent future high-risk blockchain behavior;

FIG. 5 is a diagram illustrating a graphical user interface (GUI) for displaying high-risk blockchain behavior alerts associated with monitored fiat currency accounts; and

FIG. 6 illustrates an example computing apparatus as a functional block diagram.

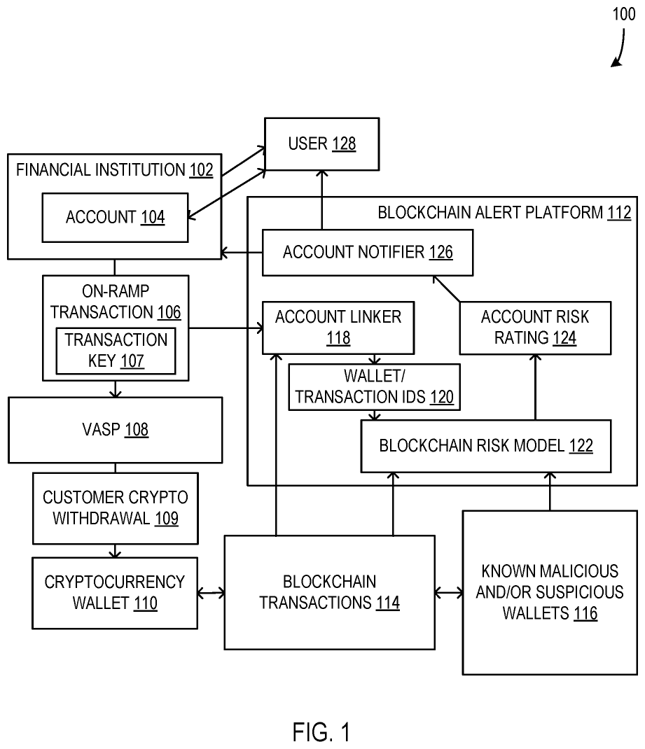

Corresponding reference characters indicate corresponding parts throughout the drawings. In FIGS. 1 to 6, the systems are illustrated as schematic drawings. The drawings may not be to scale. Any of the figures may be combined into a single example or embodiment.

### DETAILED DESCRIPTION

Aspects of the disclosure provide systems and methods for linking fiat currency accounts to blockchain transactions and/or associated cryptocurrency wallets and determining whether the fiat currency accounts are associated with high-risk blockchain transaction behavior. A blockchain alert platform obtains information about an on-ramp transaction between a fiat currency account and a virtual asset service provider (VASP) for the exchange of fiat currency and cryptocurrency. Transaction data of the on-ramp transaction and blockchain transaction data are analyzed using fuzzy logic rules to identify a group of blockchain transactions that are likely to be associated with the on-ramp transaction and the fiat currency account. The group of blockchain transactions are then analyzed using a blockchain risk model to determine whether the group of blockchain transactions indicate high-risk blockchain transaction behavior. When the blockchain risk model determines that the fiat currency account is associated with high-risk blockchain transaction behavior, the blockchain alert platform sends a notification to a financial institution (FI) or other party associated with the fiat currency account and/or takes other mitigating action to prevent future high-risk blockchain transaction behavior.

The disclosure operates in an unconventional manner at least by determining links between an on-ramp transaction and other blockchain transactions through the use of fuzzy logic rules and/or machine learning (ML)-trained modeling. By enabling the blockchain alert platform to determine such links as described herein, the identifying information of the fiat currency account does not need to be obtained by the blockchain alert platform, thereby better protecting that sensitive data from exposure. Further, the use of available transaction data and fuzzy logic to form the described links reduces the need to interact with and/or obtain additional data from the VASP or other associated entities. Such interactions with the VASP would require the agreement of the VASP and result in increased time and resource costs associated with collecting any information the VASP is willing to provide. Thus, the disclosure reduces the potential data collection costs, such as bandwidth resource costs, processing resource costs, and time costs, through the use of the described link determination processes.

Further, the disclosure uses a trained blockchain risk model in conjunction with information about known malicious and/or suspicious cryptocurrency wallets and/or other entities to efficiently determine a likelihood that funds from a fiat currency account associated with an on-ramp transaction are in some way associated with high-risk blockchain transaction behavior. Through the use of the described blockchain risk model, trained with ML techniques, the risk evaluation of large sets of related blockchain transactions can be performed rapidly, enabling the blockchain alert platform 112 to quickly respond to newfound information about behavior associated with the fiat currency account. This rapid response capability improves the likelihood that a notification or other mitigating action by the blockchain alert platform prevents further high-risk behavior.

Additionally, the disclosure enables the blockchain risk model to be fine-tuned using ML techniques during operation, such that the accuracy of the model's determinations increases over time. This capacity for improvement enables the disclosure to react to changes in high-risk behavior patterns, thereby better preventing future high-risk behavior as it changes over time.

FIG. 1 a block diagram illustrating a system configured for identifying high-risk blockchain behavior and for sending notifications associated with the identified high-risk blockchain behavior. In some examples, the system includes a financial institution (FI) 102 with which an account 104 is associated. A cryptocurrency on-ramp transaction 106 occurs in association with a VASP 108. As a result, funds from the account 104 in a fiat currency are exchanged for a cryptocurrency with which the VASP 108 is associated. In some such examples, the VASP 108 keeps the customer's cryptocurrency balance in ledger form such that there is not initially an on-chain transaction until after the customer later performs a cryptocurrency withdrawal 109. Alternatively, in other examples, the VASP 108 is a non-custodial VASP that immediately sends the cryptocurrency to a customer-provided address without waiting for a later customer cryptocurrency withdrawal 109.

A blockchain alert platform 112 obtains data of the on-ramp transaction 106 and blockchain transactions 114 and, through analysis thereof, determines a likely cryptocurrency wallet 110 to which the cryptocurrency funds of the transaction 106 were directed. The wallet ID 120 of the determined cryptocurrency wallet 110 is provided to the blockchain risk model 122 and blockchain transactions 114 associated with the cryptocurrency wallet 110 the blockchain risk model 122 generates an account risk rating 124 based on the degree to which the analyzed transactions 114 include known malicious and/or suspicious wallets 116 and/or other types of transaction analysis. If the account risk rating 124 indicates sufficiently high-risk behavior, an account notifier 126 of the blockchain alert platform 112 notifies the FI 102 and/or a user 128 associated with the account 104 of the high-risk behavior, such that any scams or other malicious behavior can be halted as soon as possible.

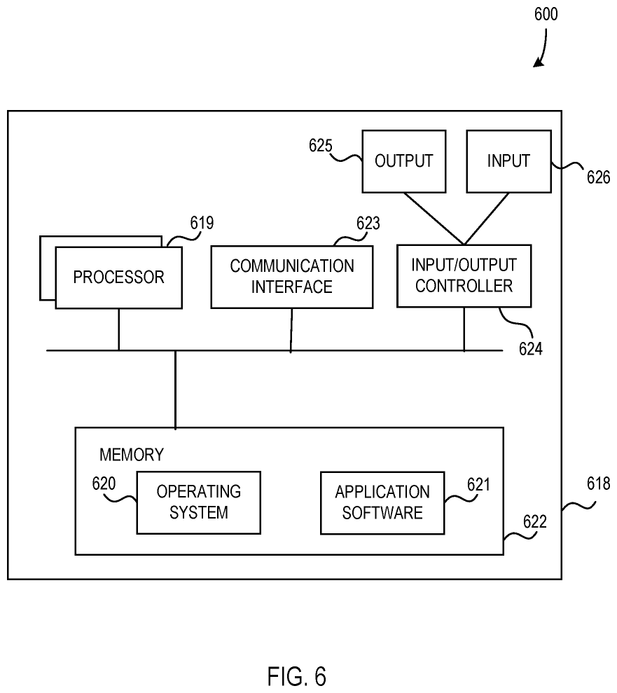

Further, in some examples, the system 100 includes one or more computing devices (e.g., the computing apparatus of FIG. 6) that are configured to communicate with each other via one or more communication networks (e.g., an intranet, the Internet, a cellular network, other wireless network, other wired network, or the like). In some examples, entities of the system 100 are configured to be distributed between the multiple computing devices and to communicate with each other via network connections. For example, the blockchain alert platform 112 is executed on a first computing device and the FI 102 is located on a second computing device within the system 100. The first computing device and second computing device are configured to communicate with each other via network connections. Alternatively, in some examples, other components of the blockchain alert platform 112 (e.g., the account linker 118, the blockchain risk model 122, the account notifier 126) are executed on separate computing devices and those separate computing devices are configured to communicate with each other via network connections during the operation of the blockchain alert platform 112. In other examples, other organizations of computing devices are used to implement system 100 without departing from the description.

In some examples, the FI 102 is a bank or other similar entity that issues and/or manages accounts 104 that are used to store fiat currency and/or track transactions involving fiat currency. In some such examples, a user 128 is enabled to open and use an account 104 associated with the FI 102, such as a bank account, checking account, savings account, credit card account, or the like. Further, in some examples, the FI 102 is enabled and/or configured to share transaction information (e.g., information associated with the on-ramp transaction 106) with the blockchain alert platform 112 as described herein.

In some examples, the blockchain alert platform 112 is part of or otherwise associated with an entity that enables transactions between the FI 102 and other FIs and/or between two or more other FIs. For example, the blockchain alert platform 112 is part of a payment network that is configured to facilitate transactions between issuing FIs and acquiring FIs, such as during credit card transactions. In some such examples, the notifications provided by the blockchain alert platform 112 are a service provided by the payment network or other similar entity to the FI 102 and/or to the user 128 associated with the account 104. Additionally, or alternatively, the blockchain alert platform 112 is configured and/or enabled to access at least some information associated with blockchain transactions 114 on one or more blockchains. Further, the blockchain alert platform 112 and/or an associated entity maintains and provides access to a set, list, or group of known malicious wallets and/or suspicious wallets that are associated with the one or more blockchains of the blockchain transactions 114. The group of known malicious and/or suspicious wallets 116 is used by the blockchain alert platform 112 in evaluating the riskiness of transaction behavior of a cryptocurrency wallet 110 as described herein.

The VASP 108 includes hardware, firmware, and/or software configured to enable the performance of on-ramp transactions 106, the management of cryptocurrency for users using cryptocurrency wallets, and/or the performance of blockchain transactions between one or more cryptocurrency wallets. Further, in some examples, the VASP 108 enables the performance of transactions that exchange cryptocurrency for fiat currency, transferring the associated value from a cryptocurrency wallet (e.g., cryptocurrency wallet 110) to an account (e.g., account 104). In some examples, the VASP 108 is configured to provide some information associated with on-ramp transactions, cryptocurrency wallets, and/or blockchain transactions to the blockchain alert platform 112, either directly or indirectly. However, in many such examples, the information provided is limited, such that the blockchain alert platform 112 uses the account linker 118 and blockchain risk model 122 in conjunction to infer and/or determine more specific risk information about specific cryptocurrency wallets 110 as described herein.

In some examples, the cryptocurrency wallet 110 is an entity that stores one or more private keys that are associated with quantities of cryptocurrency units. The private keys stored in the cryptocurrency wallet 110 enable a user thereof to prove ownership of cryptocurrency units during a blockchain transaction 114, thereby enabling the user to transfer cryptocurrency units to another party and record the transfer to the blockchain. In some such examples, the cryptocurrency wallet 110 is a virtual or digital wallet, such that it stores the private keys online (usually behind some measure of security such as two-stage encryption). Alternatively, or additionally, the cryptocurrency wallet 110 is a hardware wallet that includes a physical data storage device (e.g., a thumb drive) that is connected to a network when a user wants to use the cryptocurrency units associated with the private keys stored thereon. In still other examples, the cryptocurrency wallet 110 includes one or more private keys stored in another format, such as written down on paper or other medium.

In some examples, the blockchain transactions 114 include exchanges of cryptocurrency units through an associated blockchain, which acts as a public ledger of every transaction ever made with respect to that blockchain. Thus, blockchain transactions 114 are the shifting of data associated with cryptocurrency units between blockchain addresses and associated cryptocurrency wallets. Further, in some examples, a blockchain transaction 114 includes a sender with a sending wallet selecting to send a quantity of cryptocurrency units to a receiving wallet using an address of the receiving wallet. The initiated transaction is validated by node devices associated with the blockchain using at least private keys and public keys associated with the sending wallet. A validated transaction is held in a pool until it is confirmed using a consensus algorithm, such as a proof-of-work (PoW) algorithm or a proof-of-stake (PoS) algorithm. Once confirmed, the transaction is recorded to the blockchain, representing that the transfer of cryptographic units from the sending wallet to the receiving wallet has been completed and recorded. After a transaction is recorded to the blockchain, it can be verified to have occurred, such that, while cryptocurrency units do not have any physical form, the blockchain ledger tracks their transfer between wallets.

Further, in some examples, the blockchain alert platform 112 and/or a related entity is configured to maintain and update a group of known malicious and/or suspicious cryptocurrency wallets 116. These wallets 116 are known or suspected to be involved in some sort of malicious behavior, such as scams or the like. Because blockchain is designed to enable users to maintain significantly more anonymity than most FIs, people that perpetrate scammers are known to use cryptocurrency to better cover their tracks and avoid getting caught by law enforcement. It should be understood that the known malicious and/or suspicious wallets 116 are determined and tracked through various types of suspicious blockchain transaction behavior, but that these determination and tracking techniques are beyond the scope of the disclosure. The examples described herein assume that the wallets 116 in the group of known malicious and/or suspicious wallets 116 have been determined to be in that group to a degree of certainty and that the blockchain risk model 122 is configured to use the group of wallets 116 and/or the associated degree of certainty in generating an account risk rating 124 as described herein.

In some examples, the account linker 118 includes hardware, firmware, and/or software configured to identify a cryptocurrency wallet 110 and/or associated blockchain transactions 114 that are most likely to be associated with an account 104 based on data associated with an on-ramp transaction 106 and/or data associated with blockchain transactions 114. Further, in some examples, the blockchain alert platform 112 and/or the account linker 118 are configured to identify links between multiple fiat currency accounts and cryptocurrency wallets using large quantities of transaction data and based on patterns in that transaction data as described herein. For example, the amount and time of the on-ramp transaction 106 are compared to blockchain transactions 114 to identify possible matches. The blockchain transactions 114 that are identified as possible matches have values that are within a defined range of the amount of the on-ramp transaction 106 (e.g., within 5% to account for processing fees) and have dates and/or times that are within a defined range of the time of the on-ramp transaction 106 (e.g., within three days of the occurrence of the on-ramp transaction 106). In many cases, this set of possible matches is quite large and must be reduced to one or a few most likely matches between the account 104 and blockchain transactions 114 and/or an associated cryptocurrency wallet 110.

In some examples, to reduce the number of possible matches, the blockchain transactions 114 that are considered less likely matches are eliminated. For example, blockchain transactions 114 with exact amount matches are removed, as this represents a rare occurrence of the fees of the transaction being zero or the user already having cryptocurrency units in their account to cover the fee. Additionally, or alternatively, blockchain transactions 114 that have very common values can be eliminated as well. In another example, the set of possible matches is reduced by eliminating blockchain transactions 114 that have values that are within a relatively narrow range of the value of the on-ramp transaction 106, such that blockchain transactions 114 that are exact value matches or that differ by an amount that is less than standard processing fees for such transactions from the value of the on-ramp transaction 106 are eliminated. In other examples, other patterns of transaction data are used to eliminate possible matches and reduce the group of possible matches to a usable quantity.

After the account linker 118 has identified one or more wallet IDs and/or transaction IDs 120 that are likely to be associated with the account 104, the blockchain risk model 122 obtains transaction data of blockchain transactions 114 associated with that wallet IDs and/or transaction IDs 120 and determines a likelihood that the funds from the account 104 are associated with high-risk or malicious behavior. Further, the blockchain risk model 122 uses data associated with the known malicious and/or suspicious wallets 116 as described herein. The blockchain risk model 122 includes hardware, firmware, and/or software configured to analyze the described data in combination to determine an account risk rating 124 of the account 104 as described herein. In some examples, the blockchain risk model 122 is configured to use algorithmic evaluation and/or application of pre-defined rules to the blockchain transaction data in order to calculate or otherwise determine the account risk rating 124. Alternatively, and/or additionally, the blockchain risk model 122 includes a trained machine learning (ML) model that is trained to generate account risk ratings 124 based on input of the blockchain transaction data as described herein.

In some examples where the blockchain risk model 122 is or includes an ML model, the ML model is trained by providing training data sets of blockchain transaction data that are input to the ML model and indications of whether the blockchain transaction data represents high-risk activity, which are compared to the output of the ML model to evaluate its performance. In some such examples, when the ML model determines an account risk rating 124 that does not closely reflect an indication of the training data set, the ML model is adjusted and/or tuned in such a way that it will generate an account risk rating 124 that more closely reflects the indication if/when the input of the training data set is provided to the ML model again. This training process is iterated over many training data sets that are representative of real blockchain transaction patterns and/or obtained from historical real blockchain patterns, such that the adjustment of the ML model during training enables the ML model to determine increasingly accurate account risk ratings 124.

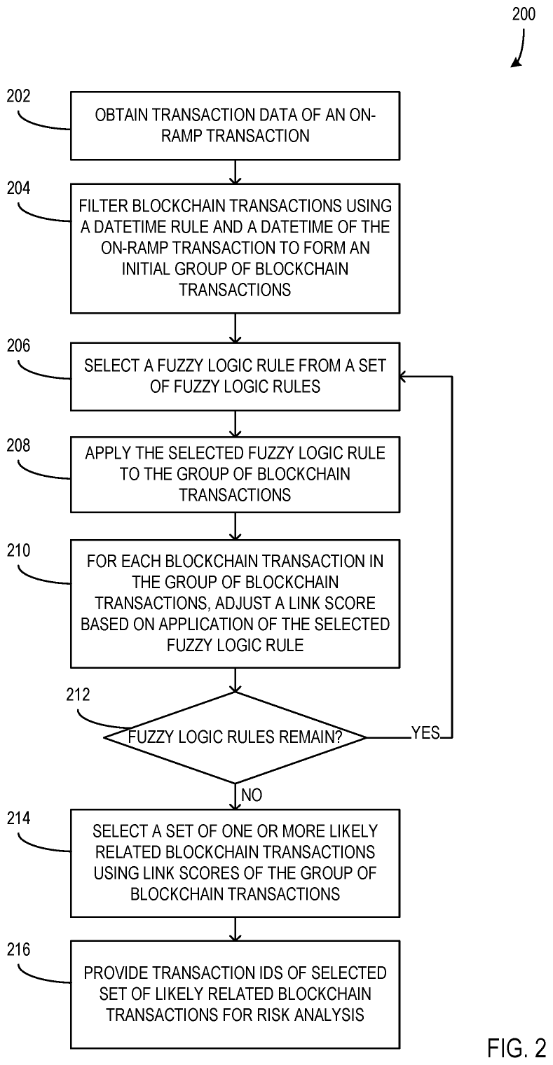

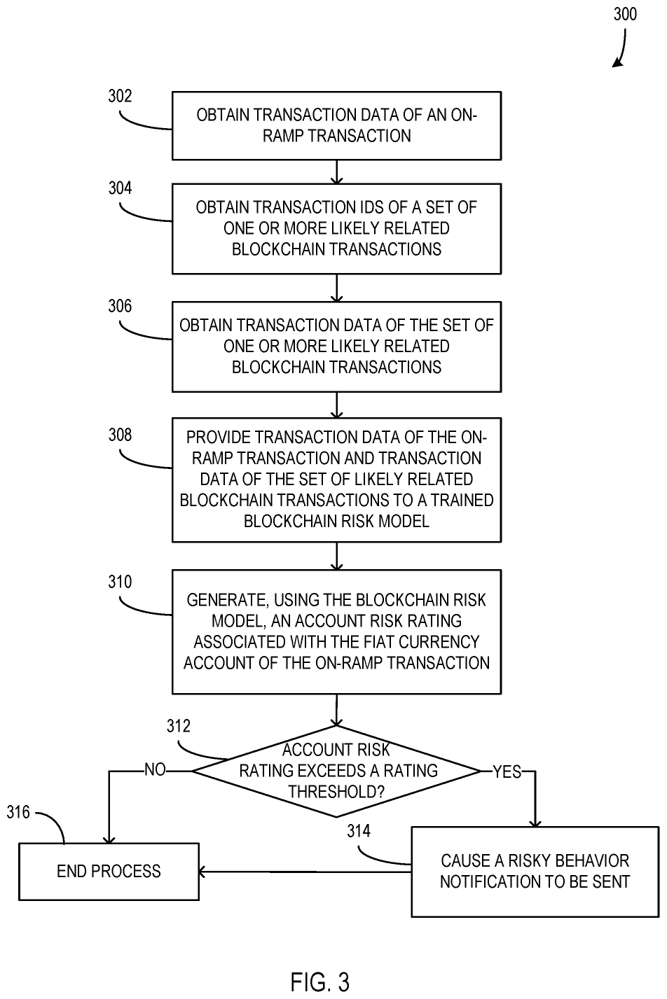

The operations of the account linker 118 and the blockchain risk model 122 are described in greater detail below with respect to FIGS. 2 and 3, respectively.

FIG. 2 is a flowchart illustrating a method 200 for linking an on-ramp transaction (e.g., on-ramp transaction 106) to one or more blockchain transactions (e.g., blockchain transactions 114) using fuzzy logic rules. In some examples, the method 200 is executed or otherwise performed in a system such as system 100 of FIG. 1. Alternatively, or additionally, in some examples, the matching and/or linking of on-ramp transactions 106 to one or more blockchain transactions 114 is performed using one or more trained models that have been trained using artificial intelligence (AI)/machine learning (ML) techniques without departing from the description.

At 202, transaction data of an on-ramp transaction is obtained. In some examples, the transaction data is provided to a blockchain alert platform and/or an account linker thereof. For example, a FI provides on-ramp transaction data to the blockchain alert platform shortly after the occurrence of the on-ramp transaction, whereby the account linker of the blockchain alert platform is enabled to use the on-ramp transaction data as described herein. Further, in some examples, the on-ramp transaction data includes an amount value, a date-time value, a transaction key that can be used to reference the on-ramp transaction, and/or the like. Additionally, or alternatively, in other examples, more, fewer, or different types of transaction data are obtained at 202 without departing from the description (e.g., data values that are associated with the FI with which the account is associated).

At 204, blockchain transactions are filtered using a date-time rule and a date-time value of the on-ramp transaction to form an initial group of blockchain transactions. In some examples, the account linker that is performing the method 200 is enabled to access some information about blockchain transactions that occur on one or more blockchains and/or in association with one or more types of cryptocurrencies. The blockchain transaction data obtained includes data that is public or otherwise easily accessible from the blockchain itself and/or some data that is obtained or received from VASPs or other entities that are associated with the blockchain transactions. Further, in some examples, transaction data of the blockchain transactions includes date-time values indicating when the blockchain transactions were initiated and/or completed. Additionally, a date-time rule is defined that describes a range of time during which blockchain transactions associated with on-ramp transactions are most likely to occur, wherein the range of time is relative to a date-time of the occurrence of the on-ramp transaction. For example, the date-time rule is defined to filter out blockchain transactions that occur more than three days after the associated on-ramp transaction. Alternatively, in other examples, other rules or thresholds are used to filter the blockchain transactions without departing from the description.

Further, it should be understood that, while this date-time rule is defined to provide an exact threshold with which to filter the blockchain transactions, in other examples, more and/or different date-time rules are used to filter the blockchain transactions (e.g., one or more fuzzy logic rules associated with the date-time of a blockchain transaction are applied to filter the transactions as described below with respect to the fuzzy logic rules).

Additionally, or alternatively, in other examples, more and/or different rules are applied to filter the possible blockchain transactions in the initial group of blockchain transactions that will be analyzed with fuzzy logic rules. For example, a precise rule filters out all blockchain transactions with amounts that are lower than a specific threshold.

At 206, a fuzzy logic rule is selected from a set of fuzzy logic rules and, at 208, the selected fuzzy logic rule is applied to the group of blockchain transactions. In some examples, the fuzzy logic rules are defined to be applied to a link score of each blockchain transaction based on the data associated with the blockchain transaction, such that the link score is strengthened or weakened. Values of data fields and/or variables of blockchain transactions can be indicative of the likelihood that one or more of those blockchain transactions are associated with the on-ramp transaction. For instance, blockchain transactions that occur within a defined time range after the on-ramp transaction are more likely to be associated with the on-ramp transaction while blockchain transactions that occur outside the defined time range are less likely to be associated with the on-ramp transaction. In some examples, a date-time fuzzy logic rule is defined to adjust the link score of a blockchain transaction based on how soon after the on-ramp transaction the blockchain transaction occurred. Such adjustments include reducing the link score of the blockchain transaction more when the blockchain transaction occurred longer after the on-ramp transaction, while reducing the link score of the blockchain transaction less when the blockchain transaction occurred sooner after the on-ramp transaction. Additionally, or alternatively, in some examples, the date-time fuzzy logic rule includes a time or time range relative to the date-time of the on-ramp transaction at which a link score of a blockchain transaction is not reduced at all, or at which a link score of a blockchain transaction is increased.

It should be understood that, in some examples, the link score of a blockchain transaction is associated with a specific on-ramp transaction and is a value between zero and one, wherein zero means that the blockchain transaction and the on-ramp transaction are very unlikely to be associated and a one means that the blockchain transaction and the on-ramp transaction are very likely to be associated. In such examples, the adjustment of the link score by the application of fuzzy logic rules includes initializing the link score to a one and then multiplying the current link score by values between zero and one to adjust it downward or upward, depending on the result of each fuzzy logic rule evaluation. Alternatively, in other examples, other methods of maintaining and/or adjusting link scores of blockchain transactions are used without departing from the description.

In some examples, other fuzzy logic rules include a fuzzy logic rule that compares the amount value of a blockchain transaction to an amount value range that is relative to the amount value of the on-ramp transaction and, based on where the amount value of the blockchain transaction falls in the amount value range, the link score of the blockchain transaction is adjusted up or down. Additionally, or alternatively, in other examples, a fuzzy logic rule is used that compares the amount value of the blockchain transaction to a narrow amount value range around the amount value of the on-ramp transaction and, based on how close the amount value of the blockchain transaction is to the exact amount value of the on-ramp transaction, the link score is adjusted downward, representing that transactions with exactly matching amounts are actually less likely to be associated with each other due to fees and other costs of blockchain systems generally.

It should be understood that, in other examples, more, fewer, and/or different fuzzy logic rules are used to adjust the link scores of the blockchain transactions without departing from the description. Further, in some other examples, AI/ML trained models are used to perform the described processes without departing from the description.

At 210, the link score of each blockchain transaction in the group of blockchain transactions is adjusted based on the application of the selected fuzzy logic rule. As described above, in some examples, the link score is adjusted based on where a data value of the blockchain transaction falls within a range of possible data values. The direction and/or amount that the link score is adjusted is defined by the fuzzy logic rule based on where the data value falls in the range of possible data values.

At 212, if fuzzy logic rules remain to be applied, the process returns to 206. Alternatively, if no fuzzy logic rules remain to be applied, the process proceeds to 214.

At 214, a set of one or more likely related blockchain transactions are selected using the link scores of the group of blockchain transactions. In some examples, the set of likely related blockchain transactions are selected based on having the highest link scores relative to all the transactions in the group of blockchain transactions. For example, the five blockchain transactions with the highest link scores are selected to be included in the set of likely related blockchain transactions. Alternatively, or additionally, the link scores of the blockchain transactions are compared to a link score threshold and blockchain transactions with link scores that exceed the link score threshold are selected to be included in the set of likely related blockchain transactions. In other examples, different methods of selecting blockchain transactions for the set of likely related blockchain transactions are used without departing from the description.

At 216, the selected set of likely related blockchain transactions are provided for use in risk analysis. In some examples, this includes providing transaction IDs of the set of likely related blockchain transactions to a blockchain risk model (e.g., blockchain risk model 122) as described herein. It should be understood that the risk analysis to be performed is in association with the account (e.g., the account 104) from which the funds were initially transferred in the on-ramp transaction 106, such that, in some examples, the transaction key 107 of the on-ramp transaction 106 and/or other identifying information of the account 104 are provided with the set of likely related blockchain transactions.

FIG. 3 is a flowchart illustrating a method 300 for generating an account risk rating (e.g., account risk rating 124) of an account (e.g., account 104) using a blockchain risk model (e.g., blockchain risk model 122). In some examples, the method 300 is executed or otherwise performed in a system such as system 100 of FIG. 1 and/or by an entity of the system such as the blockchain alert platform 112 and its associated blockchain risk model 122.

At 302, transaction data of an on-ramp transaction is obtained. At 304, transaction IDs of a set of one or more likely related blockchain transactions are obtained. And at 306, transaction data of the set of one or more likely related blockchain transactions is obtained. In some examples, the data obtained during 302-306 is obtained from an account linker (e.g., account linker 118) and/or other entity within the blockchain alert platform 112. Alternatively, or additionally, in some examples, obtaining the transaction data of the set of likely related blockchain transactions includes accessing blockchain data from the blockchain and/or associated entities using the obtained transaction IDs thereof.

At 308, the transaction data of the on-ramp transaction and the transaction data of the set of likely related blockchain transactions are provided to a trained blockchain risk model 122 and, at 310, the blockchain risk model 122 is used to generate an account risk rating associated with the fiat currency account 104 of the on-ramp transaction 106. In some examples, the blockchain risk model 122 has been trained using machine learning (ML) techniques and sets of training data to accurately generate account risk ratings that indicate likelihood that the associated account is involved with high-risk blockchain transaction behavior. In some such examples, the training data sets include sets of transaction data from on-ramp transactions and associated sets of likely related blockchain transactions. Further, the training data sets include indicators as to whether the accounts associated with the on-ramp transactions were engaged in or otherwise associated with high-risk blockchain transaction behaviors. Thus, during training, the blockchain risk model 122 is used to generate an account risk rating using the transaction data of a training data set and then that account risk rating is compared to the indicators of high-risk behavior of that training data set to determine how and/or to what degree to adjust weights and/or parameters of the blockchain risk model 122.

Further, in some examples, the indicators of high-risk behavior include information about the type of high-risk behavior that the account was engaged in or otherwise associated with, such that the blockchain risk model 122 is trained to generate account risk ratings that include risk values for different types of high-risk behavior. Some types of high-risk behavior include scam behavior, mixer behavior (e.g., a service that mixes cryptocurrency units from multiple sources in order to better avoid tracing of the associated funds through the blockchain system), gambling behavior, ransomware behavior, dark market transaction behavior, terrorism and/or other criminal behavior, or the like. Thus, in some examples, the generated account risk rating includes multiple more granular ratings for different types of high-risk behavior, which may better enable accurate notifications to be sent as described herein.

At 312, if the account risk rating exceeds a rating threshold, the process proceeds to 314. Alternatively, if the account risk rating does not exceed the rating threshold, the process ends at 316. In some examples, the rating threshold is defined as a single value that is compared to all values of the account risk rating if the account risk rating includes more than one value (e.g., the account risk rating includes different ratings for different types of high-risk behavior). As a result, when one or more of the multiple risk rating values of the account risk rating exceeds the single rating threshold, the process proceeds to 314. Alternatively, or additionally, in some examples, the rating threshold includes multiple threshold values associated with multiple types of high-risk behavior, such that the process proceeds to 314 in association with different threshold values based on the types of high-risk behavior that are evaluated.

For example, the generated account risk rating is a single value of 80 out of 100 and the rating threshold is defined as 75. Thus, the process proceeds to 314 to cause a high-risk behavior notification to be sent as described herein. Alternatively, in another example, the generated account risk rating includes a first value of 80 associated with scam behavior and a second value of 45 associated with other high-risk behaviors. Because the first value exceeds the rating threshold of 75, the process proceeds to 314 to cause a high-risk behavior notification to be sent. In some such examples, the notification includes specific information associated with likely scam behavior.

In another example, the rating threshold includes a rating threshold of 65 for mixer behavior and a rating threshold of 75 for other types of high-risk behavior. In such an example, an account risk rating that includes a rating specifically for mixer behavior that is greater than 65 but less than 75 results in the process proceeding to 314 instead of 316.

In other examples, more, fewer, or different rating thresholds are used in conjunction with more, fewer, or different account risk rating values of different types of high-risk behavior without departing from the description.

At 314, a high-risk behavior notification is sent as a result of the account risk rating exceeding the rating threshold. In some examples, the high-risk behavior notification is sent to a FI with which the on-ramp transaction is associated. Further, the high-risk behavior notification includes the transaction key 107 and/or other identifying or referencing information that enables the FI to take specific action in response to the high-risk behavior notification. In some examples, the blockchain risk model 122 and associated blockchain alert platform 112 are not provided any identifying information of the account 104 that would violate the anonymity or privacy of a user 128 of the account 104. So, the transaction key 107 is used to link the high-risk behavior notification to the appropriate on-ramp transaction 106. The FI 102 has access to account 104 information, and it can use the transaction key 107 as a reference to the account 104 without revealing private information to other parties, such as the blockchain alert platform 112.

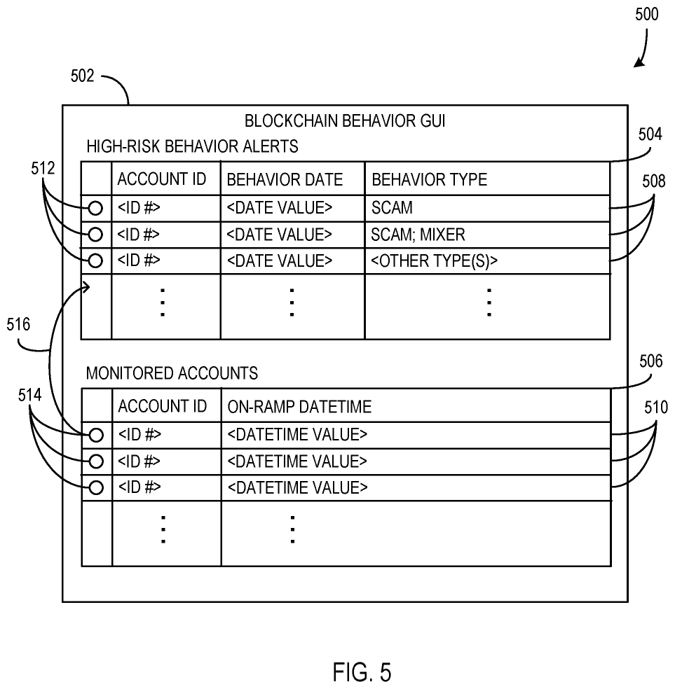

Further, in some examples, the blockchain alert platform 112 is configured to provide an interface to the FI 102 and/or the user 128 that can be used to view the information included in the high-risk behavior notification. For example, a web interface is hosted and/or provided by the blockchain alert platform 112 that displays the information of the high-risk behavior notification. In some such examples, the displayed information includes an indication of the likelihood of high-risk behavior, a description of the type of high-risk behavior detected, and/or recommended actions that can be taken to halt ongoing high-risk behavior and/or prevent future high-risk behavior. In other examples, more, less, or different information is displayed or otherwise presented by the interface of the blockchain alert platform 112 without departing from the description. An example of such an interface is illustrated and described below with respect to FIG. 5.

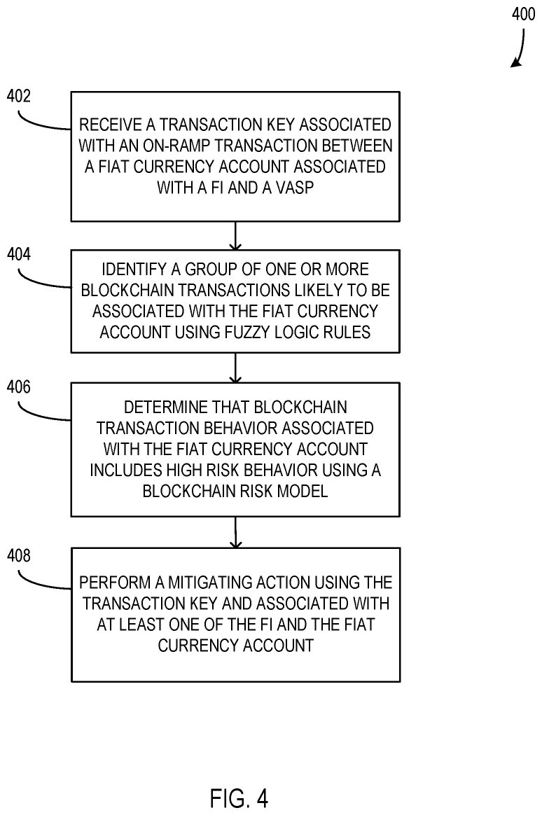

FIG. 4 is a flowchart illustrating a method 400 for identifying high-risk blockchain behavior associated with a fiat currency account (e.g., account 104) and performing a mitigating action to prevent future high-risk blockchain behavior. In some examples, the method 400 is executed or otherwise performed in a system such as system 100 of FIG. 1.

At 402, a transaction key associated with an on-ramp transaction between a fiat currency account associated with a FI and a VASP is received by an entity such as a blockchain alert platform 112. In some examples, in addition to the transaction key, transaction data associated with the on-ramp transaction is also received with the transaction key. Alternatively, or additionally, the blockchain alert platform 112 is configured to obtain transaction data of the on-ramp transaction from a source such as the FI using the transaction key. Further, in some examples, the transaction data includes data values such as the amount of the transaction and/or the date-time of the transaction.

At 404, a group of one or more blockchain transactions are identified as being likely to be associated with the fiat currency account using fuzzy logic rules. In some examples, the group of one or more blockchain transactions are identified as described above with respect to FIG. 2. Further, in some examples, the identified group of one or more blockchain transactions are used to identify one or more cryptocurrency wallets (e.g., cryptocurrency wallet 110) that are likely to be associated with the fiat currency account. Then, other blockchain transactions associated with the one or more identified cryptocurrency wallets are also included in the group of one or more blockchain transactions as being likely to be associated with the fiat currency account.

At 406, a blockchain risk model is used to determine that blockchain transaction behavior associated with the fiat currency account includes high-risk behavior. In some examples, transaction data of the on-ramp transaction and/or transaction data of the group of one or more blockchain transactions are provided to the blockchain risk model as input and the blockchain risk model generates an account risk rating (e.g., account risk rating 124) as described above with respect to FIG. 3. Further, in some examples, other data is provided to the blockchain risk model, such as identifiers of known malicious and/or suspicious cryptocurrency wallets (e.g., known malicious and/or suspicious wallets 116) and/or transaction data associated with transactions that occur after and/are associated with blockchain transactions of the group of one or more blockchain transactions. For example, a first blockchain transaction between a first wallet and a second wallet is determined to be likely to be associated with the fiat currency account. In addition to the transaction data of the first blockchain transaction, transaction data of a second blockchain transaction that is between the second wallet and a third wallet and that occurs shortly after the first blockchain transaction is provided as input to the blockchain risk model. Thus, the blockchain risk model is enabled to analyze chains of blockchain transactions that are likely to be associated with the fiat currency account.

In other examples, other types of data are used with the blockchain risk model to generate the account risk rating without departing from the description.

At 408, a mitigating action is performed using the transaction key, wherein the mitigating action is associated with at least one of the FI and/or the fiat currency account. For example, the mitigating action includes sending a high-risk behavior notification to the FI (e.g., FI 102) and/or a user (e.g., user 128) of the fiat currency account as described herein. Alternatively, or additionally, in some examples, the mitigating action includes flagging or otherwise changing a setting of a transaction processing system such that future on-ramp transactions from the fiat currency account are prevented from being completed. Such a flag can later be removed based on feedback from the FI and/or a user of the fiat currency account (e.g., the user of the fiat currency account confirms that their account is not involved in scam behavior in response to a sent high-risk behavior notification).

Further, in some examples, feedback data associated with the determination that high-risk behavior is associated with the fiat currency account is obtained and based on that obtained feedback data, the blockchain risk model is adjusted using machine learning, whereby the accuracy of the blockchain risk model is improved for future high-risk behavior determinations. For example, after a high-risk behavior notification is sent to the FI with which the fiat currency account is associated, the blockchain alert platform 112 receives feedback data back from the FI indicating that the identified high-risk behavior is not actually associated with the fiat currency account. Thus, the determination by the blockchain risk model was incorrect and weights and/or parameters of the blockchain risk model are adjusted to improve its determination accuracy in future instances that are similar to this determination. In another example, the feedback data indicates that the determination of the blockchain risk model was correct and, as a result, the model is adjusted to reinforce the determination made by the model.

Additionally, or alternatively, in some examples, the mitigating action includes displaying and/or otherwise modifying a GUI to display information associated with the determined high-risk behavior and the fiat currency account as described below with respect to FIG. 5.

Further, in some examples, the method 400 includes accessing a flow of global transactions provided by a payment network or other financial entity, which enables the systems and methods described herein to better analyze overall patterns of cryptocurrency-related transactions.

In some examples, other data is used during operations of the described systems and methods. For example, transaction data is used to detect merchants that do not accurately report aspects of transactions, such as merchant category codes (MCCs). In another example, transaction data is used to detect when multiple cryptocurrency purchases are grouped into a single blockchain transaction. In another example, transaction data is used to detect when a single cryptocurrency purchase is transferred over multiple blockchain transactions. In another example, transaction data is used to detect when a single fiat currency purchase is executed using multiple exchanges for cryptocurrency. In another example, the described systems and methods are configured to analyze transactions associated with multiple types of cryptocurrencies. In another example, transaction data associated with multiple transactions of a fiat currency account are analyzed in combination with blockchain transactions to better track suspicious actors that use the fiat currency account. In other examples, other types of analysis are performed without departing from the description.

FIG. 5 is a diagram 500 illustrating a graphical user interface (GUI) 502 for displaying high-risk blockchain behavior alerts associated with monitored fiat currency accounts (e.g., account 104). In some examples, the GUI 502 is displayed and/or otherwise executed in a system such as system 100 of FIG. 1.

The GUI 502 includes a high-risk alerts section 504 and a monitored accounts section 506. The monitored accounts section 506 includes rows 510 associated with accounts that are being monitored for high-risk behavior. The rows 510 include IDs of the accounts being monitored and date-time values of the on-ramp transaction that triggered the accounts to be modified. It should be understood that, in other examples, more, fewer, or different types of information are displayed in the monitored accounts section 506 without departing from the description.

The high-risk behavior alerts section 504 also includes rows 508 associated with fiat currency accounts for which high-risk behavior notifications or alerts have been received. The rows 508 include IDs of the accounts for which alerts have been received, behavior date values associated with the date(s) on which the high-risk behavior occurred, and behavior type values indicating the type(s) of high-risk behavior that was identified. In other examples, more, fewer, or different types of information are displayed in the high-risk behavior alerts section 504 without departing from the description.

Further, the rows of the sections 504 and 506 include icons 512 and 514, respectively, that are associated with the accounts of the rows. While circles are shown in FIG. 5, in other examples, different icons are provided for each row without departing from the description. Such icons include images and/or text, such as initials of the user of the account, letters and/or numbers that are indicative of specific aspects of the accounts or the like. In some examples, when a high-risk behavior alert is received in association with an account in the monitored accounts section 506, the icon and row associated with that account are moved from the monitored accounts section 506 to the high-risk behavior alerts section 504 at 516. Alternatively, in other examples, the GUI 502 is updated in more, fewer, or different ways in response to a high-risk behavior alert without departing from the description.

### Exemplary Operating Environment

The present disclosure is operable with a computing apparatus according to an embodiment as a functional block diagram 600 in FIG. 6. In an example, components of a computing apparatus 618 are implemented as a part of an electronic device according to one or more embodiments described in this specification. The computing apparatus 618 comprises one or more processors 619 which may be microprocessors, controllers, or any other suitable type of processors for processing computer executable instructions to control the operation of the electronic device. Alternatively, or in addition, the processor 619 is any technology capable of executing logic or instructions, such as a hard-coded machine. In some examples, platform software comprising an operating system 620 or any other suitable platform software is provided on the apparatus 618 to enable application software 621 to be executed on the device. In some examples, linking fiat currency accounts to blockchain transactions and identifying high-risk blockchain behavior associated with those fiat currency accounts as described herein is accomplished by software, hardware, and/or firmware.

In some examples, computer executable instructions are provided using any computer-readable media that is accessible by the computing apparatus 618. Computer-readable media include, for example, computer storage media such as a memory 622 and communications media. Computer storage media, such as a memory 622, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium is not a propagating signal. Propagated signals are not examples of computer storage media. Although the computer storage medium (the memory 622) is shown within the computing apparatus 618, it will be appreciated by a person skilled in the art, that, in some examples, the storage is distributed or located remotely and accessed via a network or other communication link (e.g., using a communication interface 623).

Further, in some examples, the computing apparatus 618 comprises an input/output controller 624 configured to output information to one or more output devices 625, for example a display or a speaker, which are separate from or integral to the electronic device. Additionally, or alternatively, the input/output controller 624 is configured to receive and process an input from one or more input devices 626, for example, a keyboard, a microphone, or a touchpad. In one example, the output device 625 also acts as the input device. An example of such a device is a touch sensitive display. The input/output controller 624 may also output data to devices other than the output device, e.g., a locally connected printing device. In some examples, a user provides input to the input device(s) 626 and/or receives output from the output device(s) 625.

The functionality described herein can be performed, at least in part, by one or more hardware logic components. According to an embodiment, the computing apparatus 618 is configured by the program code when executed by the processor 619 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises a processor; and a memory comprising computer program code, the memory and the computer program code configured to cause the processor to: receive a transaction key associated with an on-ramp transaction between a fiat currency account associated with a financial institution (FI) and a virtual asset service provider (VASP); identify a group of one or more blockchain transactions likely to be associated with the fiat currency account using fuzzy logic rules, on-ramp transaction data, and blockchain transaction data; determine that blockchain transaction behavior associated with the fiat currency account includes high-risk behavior using a blockchain risk model and the identified group of one or more blockchain transactions; and notify the FI of the high-risk behavior in association with the fiat currency account using the transaction key, whereby the FI is enabled to take action to prevent future high-risk behavior.

An example computerized method comprises receiving a transaction key associated with an on-ramp transaction between a fiat currency account associated with a financial institution (FI) and a virtual asset service provider (VASP); identifying a group of one or more blockchain transactions likely to be associated with the fiat currency account using fuzzy logic rules, on-ramp transaction data, and blockchain transaction data; determining that blockchain transaction behavior associated with the fiat currency account includes high-risk behavior using a blockchain risk model and the identified group of one or more blockchain transactions; and performing a mitigating action using the transaction key and associated with at least one of the FI and the fiat currency account, whereby future high-risk behavior is prevented.

One or more computer storage media have computer-executable instructions that, upon execution by a processor, cause the processor to at least: receive a transaction key associated with an on-ramp transaction between a fiat currency account associated with a financial institution (FI) and a virtual asset service provider (VASP); identify a group of one or more blockchain transactions likely to be associated with the fiat currency account using fuzzy logic rules, on-ramp transaction data, and blockchain transaction data; determine that blockchain transaction behavior associated with the fiat currency account includes high-risk behavior using a blockchain risk model and the identified group of one or more blockchain transactions; and notify the FI of the high-risk behavior in association with the fiat currency account using the transaction key, whereby the FI is enabled to take action to prevent future high-risk behavior.

Alternatively, or in addition to the other examples described herein, examples include any combination of the following:
wherein identifying the group of one or more block chain transactions includes: obtaining transaction data of an initial group of blockchain transactions from a blockchain data source; assigning initial link scores to the initial group of blockchain transactions; adjusting the link score of each blockchain transaction of the initial group of blockchain transactions using a set of one or more fuzzy logic rules and the obtained transaction data; and selecting the group of one or more blockchain transactions likely to be associated with the fiat currency account from the initial group of blockchain transactions based on the adjusted link scores initial group of blockchain transactions.
wherein determining that the blockchain transaction behavior associated with the fiat currency account includes high-risk behavior further includes: obtaining transaction data associated with the identified group of one or more blockchain transactions; providing the on-ramp transaction data and the obtained transaction data associated with the identified group of one or more blockchain transactions as input to the blockchain risk model; generating, by the blockchain risk model, an account risk rating associated with the fiat currency account; and determining that the blockchain transaction behavior associated with the fiat currency account includes high-risk behavior using the generated account risk rating and at least one defined rating threshold.
wherein the generated account risk rating is associated with a plurality of high-risk behavior types and the generated account risk rating includes an account risk rating value for each high-risk behavior type of the plurality high-risk behavior types; wherein the at least one defined rating threshold includes a defined rating threshold for each high-risk behavior type of the plurality of high-risk behavior types; and wherein determining that the blockchain transaction behavior associated with the fiat currency account includes high-risk behavior further includes determining that at least one account risk rating value of the account risk rating associated with at least one high-risk behavior type exceeds the defined rating threshold for the high-risk behavior type.
further comprising: obtaining feedback data indicating accuracy of the determining that the blockchain transaction behavior associated with the fiat currency account includes high-risk behavior; and adjusting the blockchain risk model using machine learning and based on the obtained feedback data, whereby accuracy of the blockchain risk model is improved for future high-risk behavior determinations.
further comprising preventing completion of payment network processes associated with another on-ramp transaction associated with the fiat currency account based on determining that blockchain transaction behavior associated with the fiat currency account includes high-risk behavior.
wherein performing the mitigating action associated with at least one of the FI and the fiat currency account includes: displaying a blockchain behavior graphical user interface (GUI) including blockchain transaction risk behavior information associated with accounts of the FI; and causing an icon associated with the fiat currency account to be moved to a high-risk behavior portion of the blockchain behavior GUI.

Any range or device value given herein may be extended or altered without losing the effect sought, as will be apparent to the skilled person.

Examples have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for receiving a transaction key associated with an on-ramp transaction between a fiat currency account associated with a financial institution (FI) and a virtual asset service provider (VASP); exemplary means for identifying a group of one or more blockchain transactions likely to be associated with the fiat currency account using fuzzy logic rules, on-ramp transaction data, and blockchain transaction data; exemplary means for determining that blockchain transaction behavior associated with the fiat currency account includes high-risk behavior using a blockchain risk model and the identified group of one or more blockchain transactions; and exemplary means for performing a mitigating action using the transaction key and associated with at least one of the FI and the fiat currency account, whereby future high-risk behavior is prevented.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a memory comprising computer program code, the memory and the computer program code configured to cause the processor to:
receive a transaction key associated with an on-ramp transaction between a fiat currency account associated with a financial institution (FI) and a virtual asset service provider (VASP);
identify a group of one or more blockchain transactions likely to be associated with the fiat currency account using fuzzy logic rules, on-ramp transaction data, and blockchain transaction data;
determine that blockchain transaction behavior associated with the fiat currency account includes high-risk behavior using a blockchain risk model and the identified group of one or more blockchain transactions; and
notify the FI of the high-risk behavior in association with the fiat currency account using the transaction key, whereby the FI is enabled to take action to prevent future high-risk behavior.

2. The system of claim 1, wherein identifying the group of one or more block chain transactions includes:
obtaining transaction data of an initial group of blockchain transactions from a blockchain data source;
assigning initial link scores to the initial group of blockchain transactions;
adjusting the initial link scores of one or more of the initial group of blockchain transactions using a set of one or more fuzzy logic rules and the obtained transaction data; and
selecting blockchain transactions likely to be associated with the fiat currency account from the initial group of blockchain transactions based on the adjusted initial link scores of the one or more of the initial group of blockchain transactions.

3. The system of claim 1, wherein determining that the blockchain transaction behavior associated with the fiat currency account includes high-risk behavior further includes:
obtaining transaction data associated with the identified group of one or more blockchain transactions;
providing the on-ramp transaction data and the obtained transaction data associated with the identified group of one or more blockchain transactions as input to the blockchain risk model;
generating, by the blockchain risk model, an account risk rating associated with the fiat currency account; and
determining that the blockchain transaction behavior associated with the fiat currency account includes the high-risk behavior using the generated account risk rating and at least one defined rating threshold.

4. The system of claim 3, wherein the generated account risk rating is associated with a plurality of high-risk behavior types and the generated account risk rating includes an account risk rating value for each high-risk behavior type of the plurality high-risk behavior types;
wherein the at least one defined rating threshold includes a defined rating threshold for each high-risk behavior type of the plurality of high-risk behavior types; and
wherein determining that the blockchain transaction behavior associated with the fiat currency account includes the high-risk behavior further includes determining that at least one account risk rating value of the account risk rating associated with at least one high-risk behavior type exceeds the defined rating threshold for the high-risk behavior type.

5. The system of claim 1, wherein the memory and the computer program code are configured to further cause the processor to:
obtain feedback data indicating accuracy of the determining that the blockchain transaction behavior associated with the fiat currency account includes the high-risk behavior; and
adjust the blockchain risk model using machine learning and based on the obtained feedback data, whereby accuracy of the blockchain risk model is improved for future high-risk behavior determinations.

6. The system of claim 1, wherein the memory and the computer program code are configured to further cause the processor to prevent completion of payment network processes associated with another on-ramp transaction associated with the fiat currency account based on determining that the blockchain transaction behavior associated with the fiat currency account includes the high-risk behavior.

7. The system of claim 1, wherein notifying the FI of the high-risk behavior in association with the fiat currency account using the transaction key includes:
displaying a blockchain behavior graphical user interface (GUI) including blockchain transaction risk behavior information associated with accounts of the FI; and
causing an icon associated with the fiat currency account to be moved to a high-risk behavior portion of the blockchain behavior GUI.

8. A computerized method comprising:
receiving a transaction key associated with an on-ramp transaction between a fiat currency account associated with a financial institution (FI) and a virtual asset service provider (VASP);
identifying a group of one or more blockchain transactions likely to be associated with the fiat currency account using fuzzy logic rules, on-ramp transaction data, and blockchain transaction data;
determining that blockchain transaction behavior associated with the fiat currency account includes high-risk behavior using a blockchain risk model and the identified group of one or more blockchain transactions; and
performing a mitigating action using the transaction key and associated with at least one of the FI and the fiat currency account, whereby future high-risk behavior is prevented.

9. The computerized method of claim 8, wherein identifying the group of one or more block chain transactions includes:
obtaining transaction data of an initial group of blockchain transactions from a blockchain data source;
assigning initial link scores to the initial group of blockchain transactions;
adjusting the initial link scores of one or more of the initial group of blockchain transactions using a set of one or more fuzzy logic rules and the obtained transaction data; and
selecting blockchain transactions likely to be associated with the fiat currency account from the initial group of blockchain transactions based on the adjusted initial link scores of the one or more of the initial group of blockchain transactions.

10. The computerized method of claim 8, wherein determining that the blockchain transaction behavior associated with the fiat currency account includes high-risk behavior further includes:
obtaining transaction data associated with the identified group of one or more blockchain transactions;
providing the on-ramp transaction data and the obtained transaction data associated with the identified group of one or more blockchain transactions as input to the blockchain risk model;
generating, by the blockchain risk model, an account risk rating associated with the fiat currency account; and
determining that the blockchain transaction behavior associated with the fiat currency account includes the high-risk behavior using the generated account risk rating and at least one defined rating threshold.

11. The computerized method of claim 10, wherein the generated account risk rating is associated with a plurality of high-risk behavior types and the generated account risk rating includes an account risk rating value for each high-risk behavior type of the plurality high-risk behavior types;
wherein the at least one defined rating threshold includes a defined rating threshold for each high-risk behavior type of the plurality of high-risk behavior types; and
wherein determining that the blockchain transaction behavior associated with the fiat currency account includes high-risk behavior further includes determining that at least one account risk rating value of the account risk rating associated with at least one high-risk behavior type exceeds the defined rating threshold for the high-risk behavior type.

12. The computerized method of claim 8, further comprising:
obtaining feedback data indicating accuracy of the determining that the blockchain transaction behavior associated with the fiat currency account includes the high-risk behavior; and
adjusting the blockchain risk model using machine learning and based on the obtained feedback data, whereby accuracy of the blockchain risk model is improved for future high-risk behavior determinations.

13. The computerized method of claim 8, further comprising preventing completion of payment network processes associated with another on-ramp transaction associated with the fiat currency account based on determining that the blockchain transaction behavior associated with the fiat currency account includes the high-risk behavior.

14. The computerized method of claim 8, wherein performing the mitigating action associated with at least one of the FI and the fiat currency account includes:
displaying a blockchain behavior graphical user interface (GUI) including blockchain transaction risk behavior information associated with accounts of the FI; and
causing an icon associated with the fiat currency account to be moved to a high-risk behavior portion of the blockchain behavior GUI.

15. A computer storage medium storing computer-executable instructions that, upon execution by a processor, cause the processor to at least:
receive a transaction key associated with an on-ramp transaction between a fiat currency account associated with a financial institution (FI) and a virtual asset service provider (VASP);
identify a group of one or more blockchain transactions likely to be associated with the fiat currency account using fuzzy logic rules, on-ramp transaction data, and blockchain transaction data;
determine that blockchain transaction behavior associated with the fiat currency account includes high-risk behavior using a blockchain risk model and the identified group of one or more blockchain transactions; and
notify the FI of the high-risk behavior in association with the fiat currency account using the transaction key, whereby the FI is enabled to take action to prevent future high-risk behavior.

16. The computer storage medium of claim 15, wherein identifying the group of one or more block chain transactions includes:
obtaining transaction data of an initial group of blockchain transactions from a blockchain data source;
assigning initial link scores to the initial group of blockchain transactions;
adjusting the initial link scores of one or more of the initial group of blockchain transactions using a set of one or more fuzzy logic rules and the obtained transaction data; and
selecting blockchain transactions likely to be associated with the fiat currency account from the initial group of blockchain transactions based on the adjusted initial link scores of the one or more of the initial group of blockchain transactions.

17. The computer storage medium of claim 15, wherein determining that the blockchain transaction behavior associated with the fiat currency account includes high-risk behavior further includes:
obtaining transaction data associated with the identified group of one or more blockchain transactions;
providing the on-ramp transaction data and the obtained transaction data associated with the identified group of one or more blockchain transactions as input to the blockchain risk model;
generating, by the blockchain risk model, an account risk rating associated with the fiat currency account; and
determining that the blockchain transaction behavior associated with the fiat currency account includes the high-risk behavior using the generated account risk rating and at least one defined rating threshold.

18. The computer storage medium of claim 17, wherein the generated account risk rating is associated with a plurality of high-risk behavior types and the generated account risk rating includes an account risk rating value for each high-risk behavior type of the plurality high-risk behavior types;
wherein the at least one defined rating threshold includes a defined rating threshold for each high-risk behavior type of the plurality of high-risk behavior types; and
wherein determining that the blockchain transaction behavior associated with the fiat currency account includes the high-risk behavior further includes determining that at least one account risk rating value of the account risk rating associated with at least one high-risk behavior type exceeds the defined rating threshold for the high-risk behavior type.

19. The computer storage medium of claim 15, wherein the computer-executable instructions, upon execution by the processor, further cause the processor to at least:
obtain feedback data indicating accuracy of the determining that the blockchain transaction behavior associated with the fiat currency account includes the high-risk behavior; and
adjust the blockchain risk model using machine learning and based on the obtained feedback data, whereby accuracy of the blockchain risk model is improved for future high-risk behavior determinations.

20. The computer storage medium of claim 15, wherein the computer-executable instructions, upon execution by a processor, further cause the processor to at least prevent completion of payment network processes associated with another on-ramp transaction associated with the fiat currency account based on determining that the blockchain transaction behavior associated with the fiat currency account includes the high-risk behavior.
